(19) United States
(12) Patent Application Publication
(10) Pub. No.: US 2009/0195037 A1
(43) Pub. Date: Aug. 6, 2009

(54) RECONFIGURABLE VEHICLE SEATING SYSTEM

(75) Inventors: Richard Plavetich, San Diego, CA (US); John Cupit, San Diego, CA (US); Steven Moneypenny, San Diego, CA (US); Martin Horton, San Diego, CA (US)

Correspondence Address: YOUNG BASILE, 3001 WEST BIG BEAVER ROAD, SUITE 624, TROY, MI, 48084, US

(73) Assignee: NISSAN DESIGN AMERICA, INC., San Diego, CA (US)

(21) Appl. No.: 12/023,577

(22) Filed: Jan. 31, 2008

(51) Int. Cl. B60N 2/01

(52) U.S. Cl. 297/257

(57) ABSTRACT

A vehicle seating system including a seating assembly and a first adjustment assembly. The seating assembly has a first seat portion and a second seat portion. The first adjustment assembly is configured to move the first seat portion with respect to the second seat portion between an extended position, wherein the seating assembly has a first width and a gap is defined between the first seat portion and the second seat portion, and a retracted position, wherein the seating assembly has a second width that is smaller than the first width.

### FIELD OF THE INVENTION

The invention relates to the field of seats for motor vehicles, and more particularly, to a reconfigurable vehicle seating system.

### BACKGROUND

There are numerous well-known reconfigurable seating systems for passenger vehicles. Such systems have included position adjustment of the seats, pivotal adjustment of the seats, or the ability to remove one or more of the seats entirely. However, the range of adjustment afforded by these seating systems is necessarily limited by the manner in which the seats are mounted to the vehicle as well as the relative dimensions of the seating assembly as compared to the other components within the interior of the vehicle.

### SUMMARY

One seating system for a vehicle taught herein includes a seating assembly and a first adjustment assembly. The seating assembly includes a first seat portion and a second seat portion. The first adjustment assembly is configured to move the first seat portion with respect to the second seat portion between an extended position and a retracted position. In the extended position, the seating assembly has a first width and a gap is defined between the first seat portion and the second seat portion. In the retracted position, the seating assembly has a second width that is smaller than the first width. Furthermore, the first seat portion and the second seat portion may be adjacent to one another when the first seat portion and the second seat portion are in the retracted position.

The seating system may further include a second adjustment assembly configured to move a third seat portion of the seating assembly, which may be a console, between a first position and a second position. When the third seat portion is in the first position, the third seat portion is disposed within the gap defined between the first seat portion and the second seat portion. When the third seat portion is in the second position, the third seat portion is not disposed within the gap defined between the first seat portion and the second seat portion. The first seat portion and the second seat portion may both be adjacent to the third seat portion when the first seat portion and the second seat portion are in the extended position and the third seat portion is in the first position. Also, the third seat portion may be disposed above the first seat portion and the second seat portion when the third seat portion is in the second position.

The seating system may also include a pivot support that is connected to the vehicle, wherein the seating assembly is disposed upon the pivot support for rotation with respect to the vehicle about a pivot axis, and the pivot support may be configured to rotate the seating assembly at least 180 degrees with respect to the vehicle. Accordingly, the first seat portion and the second seat portion may be disposed on opposite sides of the pivot axis, and the first adjustment assembly may be configured to move either or both of the first seat portion and the second seat portion laterally with respect to the pivot support between the extended position and the retracted position. For instance, the first adjustment assembly may be configured to move the first seat portion and the second seat portion between the extended position and the retracted position by moving the first seat portion and the second seat portion in opposite directions with respect to one another.

### BRIEF DESCRIPTION OF THE DRAWINGS

The description herein makes reference to the accompanying drawings wherein like reference numerals refer to like parts throughout the several views, and wherein:

FIG. 1 is an illustration showing the interior of a vehicle, wherein a reconfigurable seating assembly is disposed in an extended position and a third seat portion of the seating assembly is in a lowered position;

FIG. 2 is an illustration showing the interior of the vehicle, wherein the reconfigurable seating assembly is in a retracted position and the third seat portion of the seating assembly is in a raised position;

FIG. 3 is a front view of the seating assembly, wherein the reconfigurable seating assembly is in an extended position and the third seat portion of the seating assembly is in a lowered position;

FIG. 4 is a front view of the seating assembly, wherein the reconfigurable seating assembly is in a retracted position, and the third seat portion of the seating assembly is in a raised position;

FIG. 5 is an illustration showing the interior of the vehicle, wherein the reconfigurable seating assembly is in a rear-facing position;

FIG. 6 is an illustration of the interior of the vehicle, wherein the seating reconfigurable assembly is an ingress/egress position; and

FIG. 7 is an illustration of the interior of the vehicle, wherein the reconfigurable seating assembly is in a side-facing position.

### DETAILED DESCRIPTION

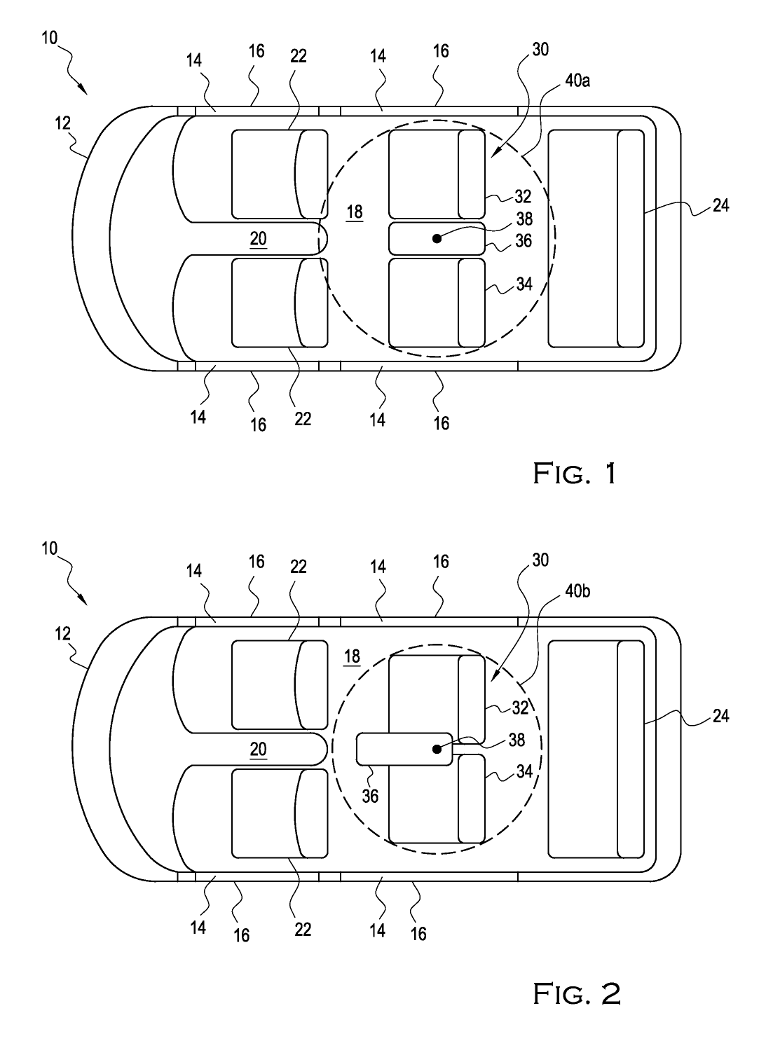

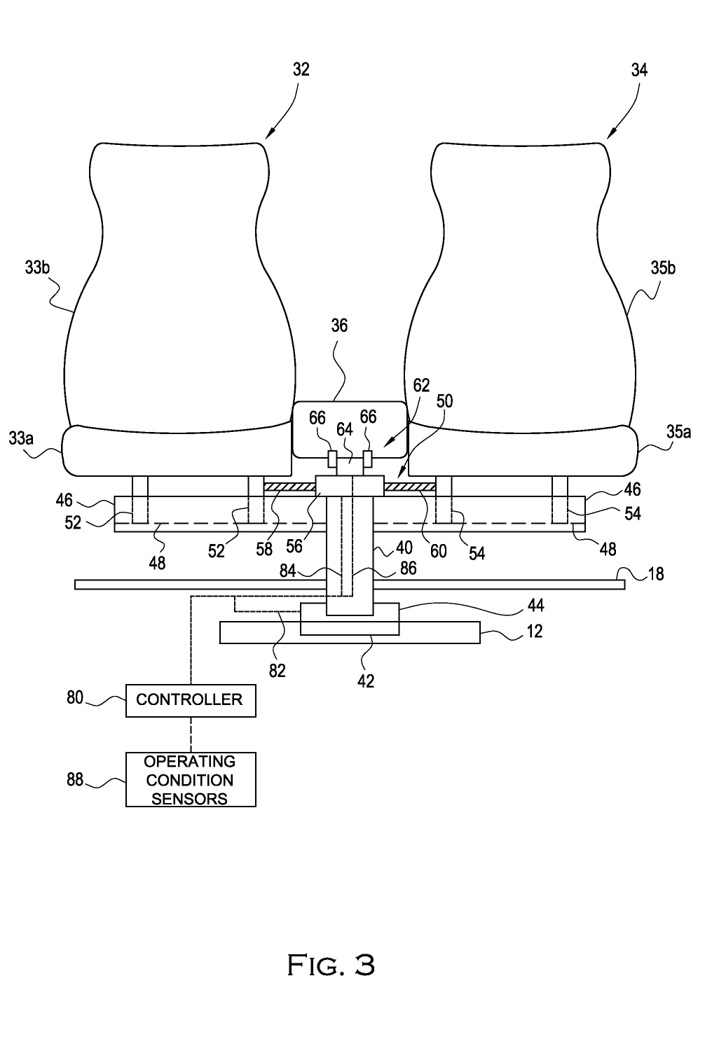

FIGS. 1-2 show a vehicle 10 that includes a reconfigurable seating assembly 30 according to the invention. Although the reconfigurable seating assembly 30 is not limited to use with any particular type of vehicle, the vehicle 10 may be a minivan, in which the reconfigurable seating assembly 30 serves as a center row of seating.

The vehicle 10 includes a vehicle body 12 having a plurality of door openings 14 formed therein. A door 16 is operatively associated with each door opening 14 to allow ingress and egress of passengers and cargo. The doors 16 may be any conventional type of vehicle door, such as sliding doors or hinged doors. A passenger compartment is defined within the vehicle body 12, and a floor 18 is provided as a support surface for fixturing the various accessories that are provided within the vehicle body 12.

At the front end of the vehicle 10, a pair of front seats 22 is supported upon the floor 18 of the vehicle body 12 to accommodate the driver of the vehicle and a front seat passenger. The front seats 22 are laterally spaced with respect to one another and separated by a console 20 that extends between the front seats 22. However, it should be understood that the front seats 22 are not limited to a pair of individual seats, but rather, the front seats 22 could be provided other forms, such as a bench seat or a split bench seat.

A rear seat 24 is located near the rear end of the vehicle 10, and is supported by the floor 18 of the vehicle body 12. As shown in the drawings, the rear seat 24 is most commonly a bench-style seat. However, it should be understood that the rear seat 24 is not limited to being a bench-style seat, but rather, various styles and configurations of seats could be employed for the rear seat 24.

The reconfigurable seating assembly 30 is located rearward of the front seats 22 and forward of the rear seat 24. The reconfigurable seating assembly 30 includes a first seat portion or first seat 32 and a second seat portion or second seat 34. The first seat 32 and the second seat 34 are arranged in a side-by-side configuration and are disposed such that they face in substantially the same direction as one another. Optionally, a third seat portion 36 may be included in the reconfigurable seating assembly 30, in between the first seat 32 and the second seat 34. The third seat portion 36 may be a console that is disposed between the first seat 32 and the second seat 34. Alternatively, the third seat portion 36 may be a seating surface that cooperates with the first seat 32 and the second seat 34 such that the reconfigurable seating assembly 30 provides a bench-style seating surface.

The reconfigurable seating assembly 30 is configured to pivot with respect to the vehicle body 12 about a pivot axis 38, as will be explained in detail herein. However, when the reconfigurable seating assembly 30 is disposed in an extended position, geometric interference between the reconfigurable seating assembly 30, the front seats 22 and the rear seat 24 restrains the reconfigurable seating assembly from pivot over more than a limited angular range. Thus, in order to allow the reconfigurable seating assembly 30 to pivot freely with respect to the vehicle body 12, without geometric interference between the reconfigurable seating assembly 30, the front seats 22 and the rear seat 24, the seating assembly 30 is configured to move between the extended position and a retracted position.

When the reconfigurable seating assembly 30 is disposed in the extended position, the first seat 32 and the second seat 34 of the reconfigurable seating assembly 30 are laterally spaced with respect to one another, such that a gap is defined between the first seat 32 and the second seat 34. As best seen in FIG. 1, the reconfigurable seating assembly 30 defines a first width or extended pivot radius 40a when the reconfigurable seating assembly 30 is in the extended position. The extended pivot radius 40a impinges upon the front seats 22, the console 20, and the rear seat 24, indicating that the reconfigurable seating assembly 30 cannot pivot freely while in the extended position, since pivotal motion of the reconfigurable seating assembly 30 will be restrained by engagement of the reconfigurable seating assembly 30 with one or more of the front seats 22, the console 20, and the rear seat 24.

To allow pivotal movement of the reconfigurable seating assembly 30, the reconfigurable seating assembly 30 may move to the retracted position, wherein the first seat 32 and the second seat 34 are moved laterally toward one another, as compared to the extended position. As best seen in FIG. 2, the reconfigurable seating assembly 30 defines a second width or retracted pivot radius 40b when the reconfigurable seating assembly 30 is in the retracted position. The retracted pivot radius 40b is smaller than the extended pivot radius 40a, and does not impinge upon the front seats 22, the console 20, or the rear seat 24. Accordingly, when the reconfigurable seating assembly 30 is in the retracted position, the reconfigurable seating assembly 30 may pivot freely with respect to the vehicle body 12, over a three-hundred and sixty degree range, without engagement of the reconfigurable seating assembly 30 with the front seats 22, the console 20, or the rear seat 24.

The third seat portion 36 is normally disposed in a first, or lowered position, wherein the third seat portion 36 is disposed in the gap between the first seat 32 and the second seat 34. Accordingly, when the third seat portion is in the lowered position, the first seat 32 and the second seat 34 are restrained from moving from the extended position to the retracted position by engagement of the first seat 32 and the second seat 34 with the when the third seat portion 36. Therefore, the third seat portion 36 is configured to move from the lowered position to a second, or raised position. In the raised position, the third seat portion 36 is not disposed within the gap between the first seat 32 and the second seat 34. Rather, in the raised position, the third seat portion 36 is disposed above the first seat 32 and the second seat 34, as well as slightly forward as compared to the lowered position, such that the third seat portion 36 does not restrain the first seat 32 and the second seat 34 from moving from the extended position to the retracted position when the third seat portion 36 is in the raised position. Thus, in order to move the first seat 32 and the second seat 34 from the extended position to the retracted position, the third seat portion 36 is first moved from the lowered position to the raised position.

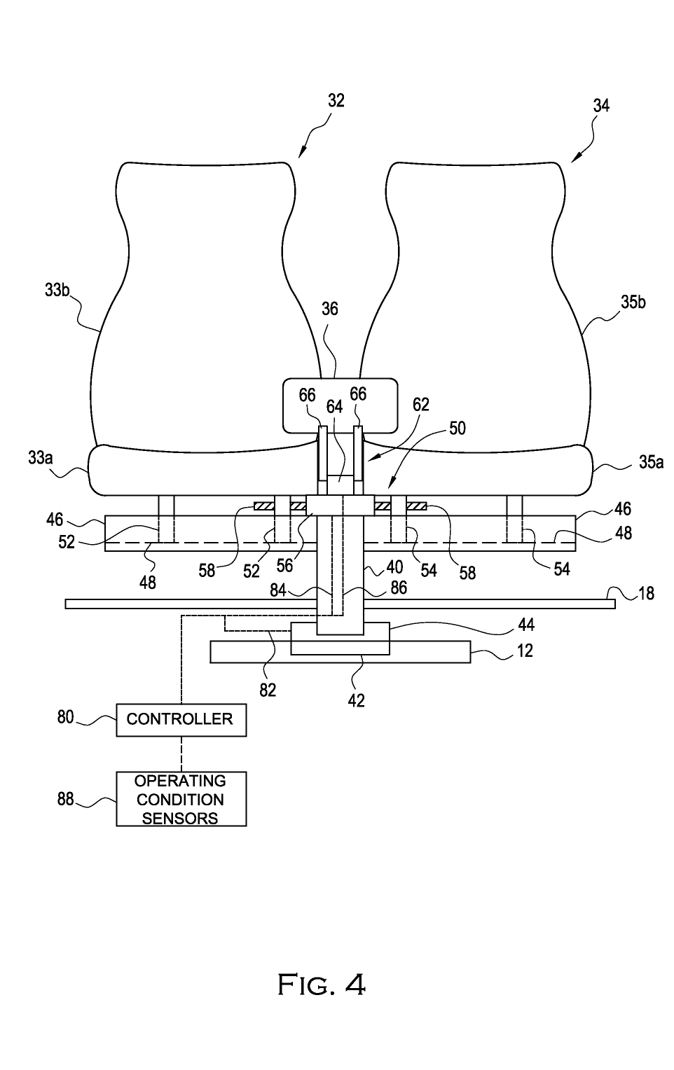

As shown in FIGS. 3-4, the reconfigurable seating assembly 30 is pivotally mounted to the vehicle body 12 by a pivot support 40. The pivot support 40 is a substantially vertically columnar member that is fabricated from a rigid material, such as metal. The pivot support 40 is connected to the vehicle body 12 by a pivotal mount 42, such as a turntable or similar structure, and extends upward through the floor 18 of the vehicle 10. A pivot drive 44 is provided on the pivotal mount 42 for driving pivotal motion of the reconfigurable seating assembly 30. In particular, the pivot drive 44 is configured to induce pivotal motion of the pivot support 40 with respect to the vehicle body 12, and thus may be selected from any number of conventional structures operable to induce pivotal motion, such as an electrical motor and associated gearing. In order to provide an operating signal to the pivot drive 44, an electrical control unit (ECU) 80 is electrically connected to the pivot drive 44 by a cable 82, as will be explained in detail herein.

In order to support the first seat 32, the second seat 34 and the third seat portion 36 in a vertically spaced relationship with respect to the floor 18, a transverse support frame 46 is connected to the pivot support 40 near a top end thereof. The transverse support frame 46 is a substantially horizontal support structure, such as a framework of metal tubular elements. So that the first seat 32 and the second seat 34 may be disposed on opposite sides of the pivot support 40, the pivot support 40 is connected to the transverse support frame 46 near the middle of the transverse support frame 46. One or more upward-facing tracks 48 are provided on the transverse support frame 46, to allow the first seat 32 and the second seat 34 to be slidably mounted to the transverse support frame 46.

A first adjustment assembly 50 is disposed upon the transverse support frame 46 to provide for lateral movement of the first seat 32 and the second seat 34 between the extended position, shown in FIG. 3, and the retracted position, shown in FIG. 4. The first adjustment assembly is configured to move the first seat 32 and the second seat 34 between the extended and retracted positions by moving one or both of the first seat 32 and the second seat 34 laterally with respect to the pivot support 40 along the transverse support frame 46. For example, when moving from the extended position to the retracted position, the first seat 32 and the second seat 34 may both move toward one another, and thus toward the pivot support 40. Conversely, when moving from the retracted position to the extended position, the first seat 32 and the second seat 34 may both move away from one another, and thus away from the pivot support 40.

The first adjustment assembly 50 includes a first pair of sliding mounts 52 and a second pair of sliding mounts 54 that are slidably disposed in the tracks 48 of the transverse support frame 46. The first pair of sliding mounts 52 is connected to a seat base 33a of the first seat 32. The second pair of sliding mounts is connected to a seat base 35a of the second seat 34.

The first adjustment assembly 50 also includes a lateral drive 56, a first drive member 58 and a second drive member 60 that cooperate to drive movement of the first seat 32 and the second seat 34 between the extended position and the retracted position. In particular, the lateral drive 56 is connected to at least one sliding mount of the first pair of sliding mounts 52 by the first drive member 58 and to at least one sliding mount of the second pair of sliding mounts 54 by the second drive member 60. The lateral drive 56 and the first and second drive members 58, 60 may be selected from any conventional structures operative to slide the first and second sliding mounts 52, 54 along the tracks 48 of the transverse support member, such as an electric motor driven ball screw actuator. In order to provide an operating signal to the lateral drive 56, the ECU 80 is electrically connected to the lateral drive 56 by a cable 84.

A second adjustment assembly 62 is provided on the transverse support frame 46 to move the third seat portion 36 between the lowered position and the raised position. The second adjustment assembly 62 includes a drive unit 64 and a linkage 66 that connects the drive unit 64 to the third seat portion 36. The drive unit 64 and the linkage 66 are configured to move the third seat portion 36 upward, above the seat bases 33a, 35a of the first and second seats 32, 34. The drive unit 64 and the linkage 66 are also configured to move the third seat portion 36 forward, to the front of a seat back 33b of the first seat 32 and a seat back 35b of the second seat 34. The drive unit 64 and the linkage 66 may be any of numerous conventional structures. For example, the drive unit 64 may be an electric motor and associated gearing, while the linkage 66 may be a rigid bar, a scissor linkage, or a telescoping member. In order to provide an operating signal to the drive unit 64, the ECU 80 is electrically connected to the drive unit 64 by a cable 86.

In response to a request from a user, the ECU 80 controls and coordinates the pivot drive 44, the lateral drive 56 and the drive unit 64 to change the configuration of the reconfigurable seating assembly 30. The ECU 80 may be, for example, a microcomputer including a random access memory (RAM), a read-only memory (ROM) and a central processing unit (CPU) in addition to various input and output connections. Generally, the control functions described herein and associated with each of the parts are performed by execution by the CPU of one or more software programs stored in ROM. Of course, some or all of the parts and their associated functions can be implemented by hardware components.

In order to prevent movement of the reconfigurable seating assembly 30 while the vehicle 10 is in motion, the ECU 80 may be connected to one or more operating condition sensors 88 that are configured to detect an operating state of the vehicle 10. For example, the operating condition sensors may be operable to detect whether the transmission (not shown) of the vehicle 10 is shifted to “park,” in which case the ECU 80 would determine that the vehicle 10 is not in motion. If the ECU 80, using the operating condition sensors 88, determines that the vehicle 10 is in motion, the ECU will not actuate the pivot drive 44, the lateral drive 56 or the drive unit 64. Conversely, if the ECU 80 determines that the vehicle 10 is not in motion, the ECU 80 will allow actuation of the pivot drive 44, the lateral drive 56 and the drive unit 64.

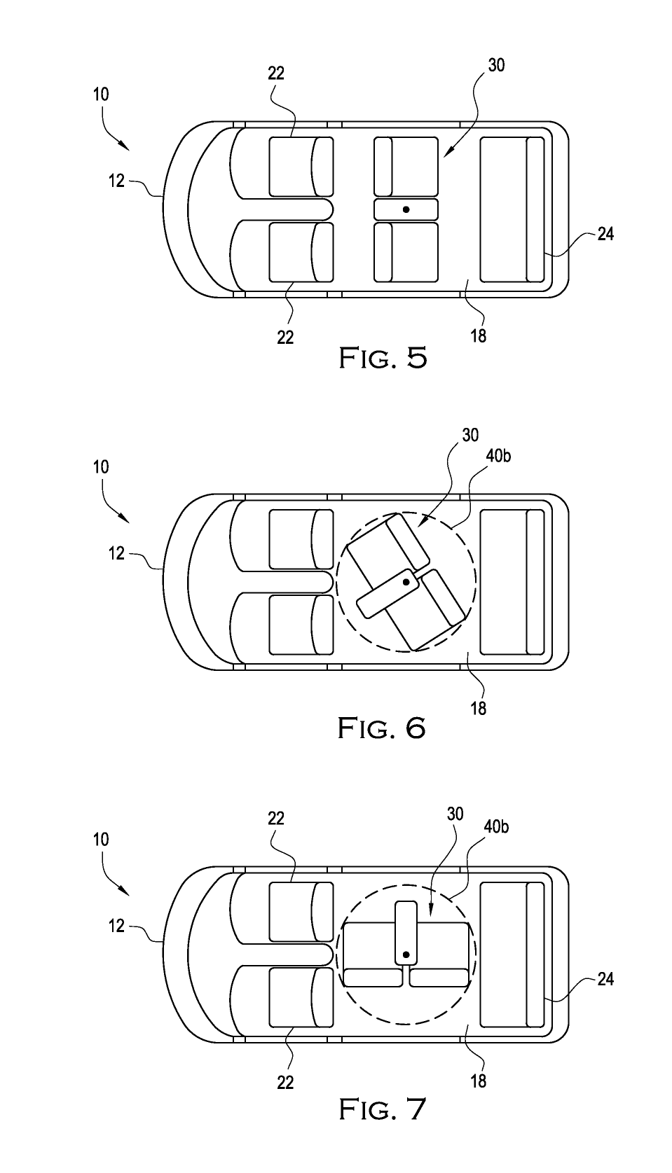

After determining that the vehicle 10 is not in motion, the ECU 80 actuates the drive unit 64 of the second adjustment assembly 62 to move the third seat portion 36 from the lowered position to the raised position. After the third seat portion 36 reaches the raised position, the ECU 80 actuates the lateral drive 56 of the first adjustment assembly to move the first seat 32 and the second seat 34 from the extended position to the retracted position. Subsequently, the reconfigurable seating assembly 30 may be pivoted from the forward-facing orientation of FIGS. 1-2 using the pivot drive 44. The reconfigurable seating assembly 30 may be pivoted to any desired angular orientation of the reconfigurable seating assembly 30 with respect to the vehicle body 12. For example, the ECU 80 may actuate the pivot drive 44 to pivot the reconfigurable seating assembly 30 by one hundred and eighty degrees, to a rear-facing orientation, wherein the first seat 32 and the second seat 34 face the rear seat 24, as shown in FIG. 5. In the rear-facing orientation, the first seat 32 and the second seat 34 may be moved to the extended position, and the third seat portion 36 may be moved to the lowered position. As another example, the ECU 80 may actuate the pivot drive 44 to pivot the reconfigurable seating assembly 30 by approximately 30 to 60 degrees from the front-facing orientation to an ingress/egress orientation, as shown in FIG. 6. In the ingress/egress orientation, a clear path is provided between one of the door openings 14 and the rear seat 24 to facilitate ingress and egress of rear seat passengers. As a further example, the ECU 80 may actuate the pivot drive 44 to pivot the reconfigurable seating assembly 30 by 90 degrees to a side-facing orientation, as shown in FIG. 7, wherein the first seat 32 and the second seat 34 face one of the doors 16 to allow passengers to observe happenings outside the vehicle through a window (not shown) in the door 16 while the vehicle 10 is parked.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A seating system for a vehicle, comprising:
a seating assembly having a first seat portion and a second seat portion; and
a first adjustment assembly configured to move the first seat portion with respect to the second seat portion between an extended position, wherein the seating assembly has a first width and a gap is defined between the first seat portion and the second seat portion, and a retracted position, wherein the seating assembly has a second width that is smaller than the first width.

2. The seating system of claim 1, further comprising:
the seating assembly having a third seat portion;
a second adjustment assembly configured to move the third seat portion between a first position, wherein the third seat portion is disposed within the gap defined between the first seat portion and the second seat portion, and a second position, wherein the third seat portion is not disposed within the gap defined between the first seat portion and the second seat portion.

3. The seating system of claim 2, wherein the third seat portion is disposed above the first seat portion and the second seat portion when the third seat portion is in the second position.

4. The seating system of claim 2, wherein the first seat portion and the second seat portion are both adjacent to the third seat portion when the first seat portion and the second seat portion are in the extended position and the third seat portion is in the first position.

5. The seating system of claim 2, wherein the third seat portion is a console.

6. The seating system of claim 1, wherein the first seat portion and the second seat portion are adjacent to one another when the first seat portion and the second seat portion are in the retracted position.

7. The seating system of claim 1, further comprising:
a pivot support connected to the vehicle, wherein the seating assembly is disposed upon the pivot support for rotation with respect to the vehicle about a pivot axis.

8. The seating system of claim 7, wherein the first seat portion and the second seat portion are disposed on opposite sides of the pivot axis.

9. The seating system of claim 7, wherein the first adjustment assembly is configured to move the first seat portion laterally with respect to the pivot support between the extended position and the retracted position.

10. The seating system of claim 7, wherein the first adjustment assembly is configured to move the first seat portion and the second seat portion laterally with respect to the pivot support between the extended position and the retracted position.

11. The seating system of claim 7, wherein the first adjustment assembly is configured to move the first seat portion and the second seat portion between the extended position and the retracted position by moving the first seat portion and the second seat portion in opposite directions with respect to one another.

12. The seating system of claim 7, wherein the pivot support is configured to rotate the seating assembly at least 180 degrees with respect to the vehicle.

13. A seating system for a vehicle, comprising:
a seating assembly having a first seat portion, a second seat portion, and a third seat portion;
a first adjustment assembly configured to move the first seat portion with respect to the second seat portion between an extended position, wherein the seating assembly has a first width and a gap is defined between the first seat portion and the second seat portion, and a retracted position, wherein the seating assembly has a second width that is smaller than the first width;
a second adjustment assembly configured to move the third seat portion between a first position, wherein the third seat portion is disposed within the gap defined between the first seat portion and the second seat portion, and a second position, wherein the third seat portion is not disposed within the gap defined between the first seat portion and the second seat portion.

14. The seating system of claim 13, wherein the third seat portion is disposed above the first seat portion and the second seat portion when the third seat portion is in the second position.

15. The seating system of claim 13, wherein the first seat portion and the second seat portion are both adjacent to the third seat portion when the first seat portion and the second seat portion are in the extended position and the third seat portion is in the first position.

16. A vehicle, comprising:
a vehicle body having a door opening formed therein;
a support surface disposed within the vehicle body;
a transverse support frame disposed within the vehicle body and vertically spaced from the floor, the transverse support frame having a first end and a second end;
a first seating assembly supported by the transverse support frame and having a first seat portion, a second seat portion, and a third seat portion, wherein the first seat portion is disposed adjacent to the first end of the transverse support frame and the second seat portion is disposed adjacent to the second end of the transverse support frame;
a first adjustment assembly configured to move the first seat portion and the second seat portion laterally along the transverse frame between an extended position, wherein the first seating assembly has a first width and a gap is defined between the first seat portion and the second seat portion, and a retracted position, wherein the first seating assembly has a second width that is smaller than the first width;
a second adjustment assembly configured to move the third seat portion between a first position, wherein the third seat portion is disposed within the gap defined between the first seat portion and the second seat portion, and a second position, wherein the third seat portion is disposed above the first seat portion and the second seat portion; and
a second seating assembly disposed within the vehicle body, supported by the floor, and longitudinally spaced from the first seating assembly.

17. The vehicle of claim 16, further comprising:
a pivot support connected to the vehicle body for rotation with respect to the vehicle body about a pivot axis and connected to the transverse support frame at a location between the first and second ends of the transverse support frame for rotation of the transverse support frame with the pivot support.

18. The vehicle of claim 17, further comprising:
a pivot motor configured to drive rotation of the pivot support;
the first adjustment assembly having a first adjustment motor configured to drive movement of the first seat portion and the second seat portion between the extended position and the retracted position; and
the second adjustment assembly having a second adjustment motor configured to drive movement of the third seat portion between the first position and the second position.

19. The vehicle of claim 18, further comprising:
a controller electrically connected to the pivot motor, the first adjustment motor, and the second adjustment motor, wherein the controller is configured to selectively restrain operation of the pivot motor, the first adjustment motor, and the second adjustment motor based on an operating condition of the vehicle.

20. The vehicle of claim 17, wherein the pivot support is configured to pivot the first seating assembly with respect to the vehicle body between a first angular position and a second angular position, the first seating assembly is restricted from moving from the first angular position to the second angular position when the first seating assembly is in the extended position by engagement of the first seating assembly with the second seating assembly, and the first seating assembly is not restricted against moving from the first angular position to the second angular position when the first seating assembly is in the retracted position.
